(19) United States
(12) Patent Application Publication
(10) Pub. No.: US 2019/0346823 A1
(43) Pub. Date: Nov. 14, 2019

(54) WIRELESS CONDITION MONITORING SENSOR

(71) Applicant: Owens Corning Intellectual Capital, LLC, Toledo, OH (US)

(72) Inventors: Gary D. Josebeck, Greensburg, PA (US); Taylor B. Depew, Pemberville, OH (US)

(21) Appl. No.: 16/400,378

(22) Filed: May 1, 2019

Related U.S. Application Data
(60) Provisional application No. 62/670,023, filed on May 11, 2018.

(51) Int. Cl. G05B 19/4065; G05B 19/418

(52) U.S. Cl. CPC G05B 19/4065; G05B 19/4184; G05B 2219/37351; G05B 2219/37428; G05B 2219/37434; G05B 2219/37027

(57) ABSTRACT

A sensor for use in a condition monitoring system or method includes multiple discrete sensing technologies embedded therein. The sensor is able to monitor three or more different parameters of condition of a machine simultaneously.

### CROSS REFERENCE TO RELATED APPLICATION

This U.S. patent application claims the benefit of and priority to U.S. provisional patent application Ser. No. 62/670,023 filed on May 11, 2018, the entire disclosure of which is incorporated herein by reference.

### FIELD

The general inventive concepts relate to systems for and methods of condition monitoring and, more specifically, to an improved sensor for use in such systems and methods.

### BACKGROUND

Condition monitoring (CM) is the process of monitoring a parameter of condition in machinery (vibration, temperature, etc.), for example, in order to identify a significant change which is indicative of a developing fault. More generally, CM involves determining the condition of machinery while in operation. CM is a useful tool for predictive maintenance. The use of CM allows maintenance to be scheduled, or other actions to be taken, to prevent damage and avoid its consequences.

Often, a CM system will include sensors that are installed on or in proximity to the equipment to be monitored, as well as other logic (e.g., software and/or hardware) for processing information received from the sensors.

Conventional CM sensors typically include only one sensing technology due to internal size limitations. Accordingly, these sensors are limited to monitoring a single parameter or group of related parameters. As a result, use of such conventional sensors in a complex CM system has many drawbacks. For example, there may be an increased cost in having to purchase many discrete sensors to monitor different parameters of condition for a machine. Additionally, to the extent that each sensor requires cabling (e.g., for power, communications, etc.), installation of the multiple sensors on or near the machine may require the use of conduits to protect this cabling. The conduits also represent an increased cost. Furthermore, the conduits can complicate the process of performing maintenance on the machine, as the conduits may need to be relocated so that the maintenance can be performed and then reinstalled thereafter.

In view of the above, there is an unmet need for an improved CM sensor that includes multiple discrete sensing technologies therein. The improved CM sensor can monitor three or more different parameters of condition of a machine simultaneously.

### SUMMARY

The general inventive concepts relate to and contemplate systems for and methods of condition monitoring and, more specifically, to an improved sensor for use in such systems and methods.

The improved sensor includes multiple discrete sensing technologies embedded therein. Consequently, the sensor is able to monitor a plurality of different parameters of condition of a machine. In some exemplary embodiments, the sensor is able to monitor three or more different parameters of condition of a machine.

In one exemplary embodiment, the sensor includes a “triaxial” vibration sensing module.

In one exemplary embodiment, the sensor includes a temperature sensing module.

In one exemplary embodiment, the sensor includes an ultrasonic emissions sensing module.

In one exemplary embodiment, a condition monitoring system using one or more of the improved sensors is disclosed.

In one exemplary embodiment, a condition monitoring method using one or more of the improved sensors is disclosed.

Numerous other aspects, advantages, and/or features of the general inventive concepts will become more readily apparent from the following detailed description of exemplary embodiments, from the claims, and from the accompanying drawings being submitted herewith.

### BRIEF DESCRIPTION OF THE DRAWINGS

The general inventive concepts as well as embodiments and advantages thereof are described below in greater detail, by way of example, with reference to the drawings in which:

FIGS. 1A-1B illustrate a CM sensor, according to an exemplary embodiment of the invention. FIG. 1A is a diagram showing a side elevational view of the CM sensor. FIG. 1B is a diagram showing a top plan view of the CM sensor.

FIG. 2 illustrates a system for monitoring machinery using the CM sensor of FIGS. 1A and 1B, according to an exemplary embodiment.

FIG. 3 illustrates a method of monitoring machinery using the CM sensor of FIGS. 1A and 1B, according to an exemplary embodiment.

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

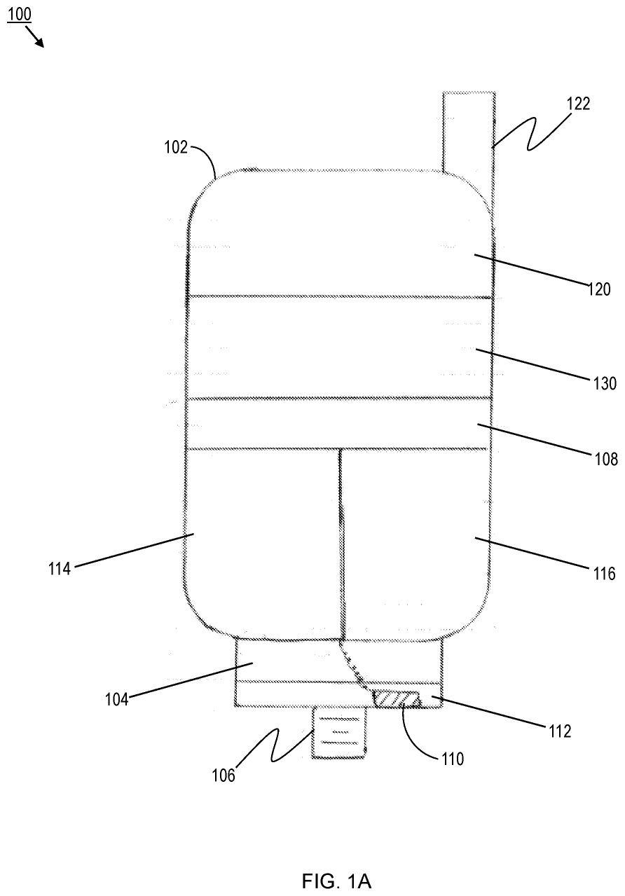

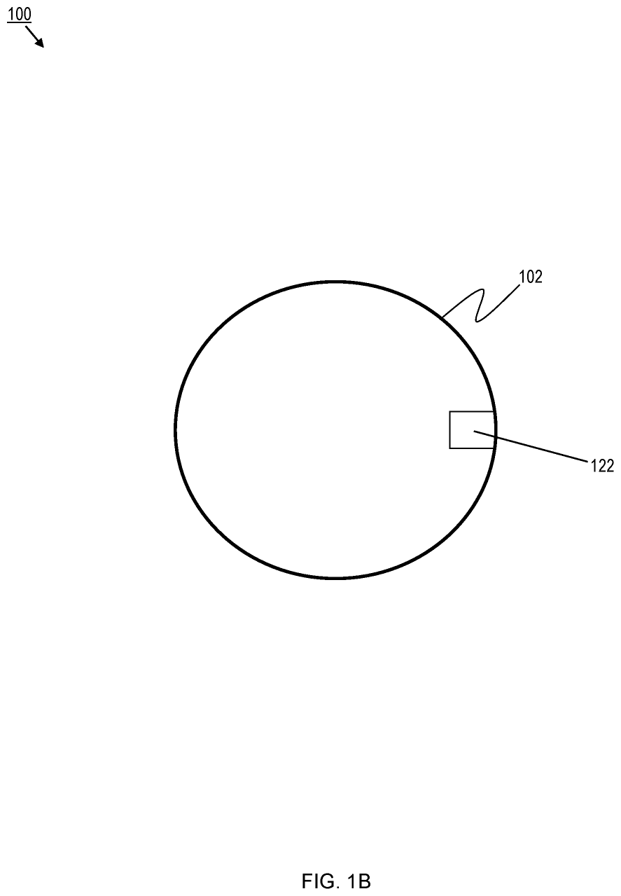

A condition monitoring (CM) sensor 100, according to one exemplary embodiment, will be described with reference to FIGS. 1A and 1B to introduce and further illustrate the general inventive concepts.

The CM sensor 100 includes a housing 102 in which multiple sensing technologies are embedded. The housing 102 can have any shape or profile suitable for housing the sensing technologies and related components, as described herein. As shown in FIG. 1B, the exemplary CM sensor 100 has a predominantly cylindrical profile.

The housing 102 can have any size suitable for housing the sensing technologies and related components, as described herein. Typically, the housing 102 will be relatively small so as to be readily transportable to an installation site and minimally obtrusive upon installation.

For the exemplary CM sensor 100, the housing 102 has a height of approximately 3.0 inches and a diameter of approximately 1.25 inches. In the case of another exemplary embodiment having a non-cylindrical housing, the dimensions could be approximately 3.0 inches (height), 1.25 inches (depth), and 1.25 inches (width).

A mounting puck base 104 extends from an end of the housing 102. The mounting puck base 104 includes a threaded member 106 extending therefrom. The threaded member 106 is designed to interface with corresponding structure (e.g., a hex nut) disposed on the machinery to be monitored. In this manner, the mounting puck base 104 and the threaded member 106 constitute a mounting means of the CM sensor 100.

As noted above, multiple sensing technologies are embedded in the housing 102 of the CM sensor 100. In general, two or more discrete sensing technologies are embedded in a unitary housing. In the exemplary CM sensor 100, three distinct sensing technologies are embedded in its housing 102.

A first sensing technology embedded in the housing 102 of the CM sensor 100 is a temperature module 108. Any temperature monitoring technology operable to be embedded in the housing 102 (and providing the desired level of accuracy for a particular application) can be used. This could include the use of contact and/or non-contact temperature sensors. Examples of such temperature monitoring technology include, but are not limited to, thermocouple, resistor, semiconductor, and infrared (IR). In the CM sensor 100, the temperature module 104 uses a resistance temperature detector (RTD) 110. An RTD is a temperature sensor that includes a resistor that changes resistance as its temperature changes. In some exemplary embodiments, at least a portion of the RTD 110 is mounted in the puck base 104. In some exemplary embodiments, at least a portion of the RTD 110 is situated within a heat dissipater 112, which is a layer of material adjacent to the mounting puck base 104. The heat dissipater 112 is a web of metal (e.g., steel) that acts to remove heat that is transmitted from the surface of the machinery being monitored. In this manner, the heat dissipater 112 removes excess heat (through convection and radiation) that could otherwise be harmful to the CM sensor 110 and the components situated therein. In this case, the RTD 110 is positioned within the heat dissipater 112 so as to be offset from the threaded member 106. Consequently, the RTD 110 can be in contact with (or otherwise in close proximity to) the machinery being monitored, when the CM sensor 100 is mounted thereon.

A second sensing technology embedded in the housing 102 of the CM sensor 100 is a vibration module 114. Any vibration monitoring technology operable to be embedded in the housing 102 (and providing the desired level of accuracy for a particular application) can be used. In the CM sensor 100, the vibration module 114 uses a three-axis (i.e., x, y, z) accelerometer (not shown). Thus, three discrete data points are generated by the vibration module 114. The vibration module 114 is able to sense vibrations that travel through the mounting puck base 104 and the heat dissipater 112 (if used), and into the housing 102 of the CM sensor 100.

A third sensing technology embedded in the housing 102 of the CM sensor 100 is an ultrasonic emissions (UE) module 116. Any UE monitoring technology operable to be embedded in the housing 102 (and providing the desired level of accuracy for a particular application) can be used. This could include the use of contact and/or non-contact UE sensors. In the CM sensor 100, the UE module 116 uses an ultrasonic transducer (not shown) that is capable of detecting high frequency sound emissions, “ultrasonic,” produced by the machinery being monitored, when the CM sensor 100 is mounted thereon. Typically, these frequencies will range from 20 kHz to 100 kHz.

The housing 102 of the CM sensor 100 also includes a communications module 120 enclosed therein. The communications module 120 can use any communications technology/protocol suitable for transmitting data from the CM sensor 100 to an external source. In the CM sensor 100, the communications module 120 supports wireless communication using an antenna 122. A size/length of the antenna 122 can vary depending on the required transmission strength. In the event the external source is remote from the environment in which the CM sensor 100 is installed (or otherwise outside the range of the communications module 120), an intermediate communications means (not shown), such as a signal repeater or transponder, can be used to relay the data received from the communications module 120 to the external source. For example, the data could be relayed over a cellular network, a Wi-Fi network, the Internet, etc. The external source can analyze the data in real time and/or store the data for subsequent processing. In some exemplary embodiments, at least some data analysis and/or storage could be done within the CM sensor 100.

Finally, the housing 102 of the CM sensor 100 includes a power module 130. The power module 130 provides the necessary power for all of the components within the CM sensor 100 requiring power including, for example, one or more of the communications module 120, the temperature module 108, the vibration module 114, and the UE module 116. The power module 130 would also power other components within the CM sensor 100 not detailed herein. For example, an onboard timer or clock, which does not “sleep,” is used to tell the sensing modules when to “wake” and take their readings. In the case of the CM sensor 100, the power requirements are managed so that the CM sensor 100 can be powered by one or more batteries situated within the housing 102. In some exemplary embodiments, the batteries are rechargeable. In some exemplary embodiments, the batteries are rechargeable without removing the batteries from the housing 102. In some exemplary embodiments, one or more capacitors are used to power at least some of the components within the CM sensor 100.

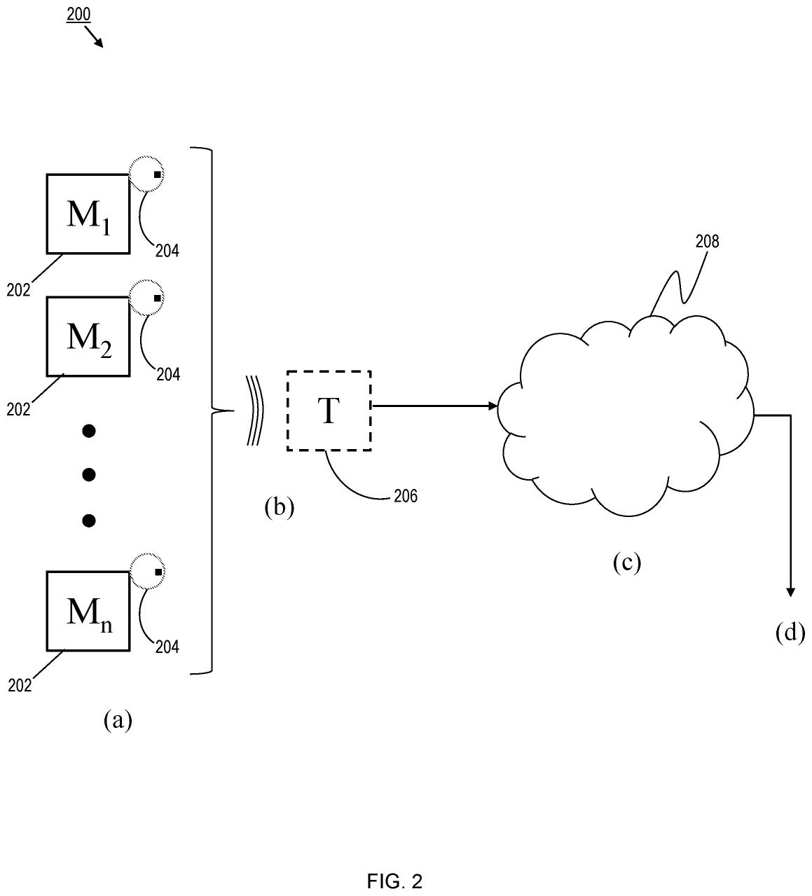

A system 200 for monitoring machinery and/or associated structure, according to an exemplary embodiment, is shown in FIG. 2. In the system 200, any number n of machines 202 to be monitored have a sensor 204 (e.g., the CM sensor 100) interfaced therewith. Each of the sensors 204 is monitoring multiple parameters of condition for the corresponding machines 202 in real-time. For example, the sensors 204 measure localized temperature, vibration, and ultrasonic emissions associated with the machines 204 and surrounding structure. The measured data is transmitted wirelessly from the sensors 204. If the data needs to be carried over a great distance, an optional repeater or transponder 206 can be used to relay the data to the Internet 208 or some other communications network, such as a Wi-Fi network, cellular network, etc. The Internet 208 or other communications network can then carry the data to a remote location for analysis/processing thereof. Thus, the system 200 involves the steps of (a) data generation, (b and c) data transmission, and (d) data receipt/processing.

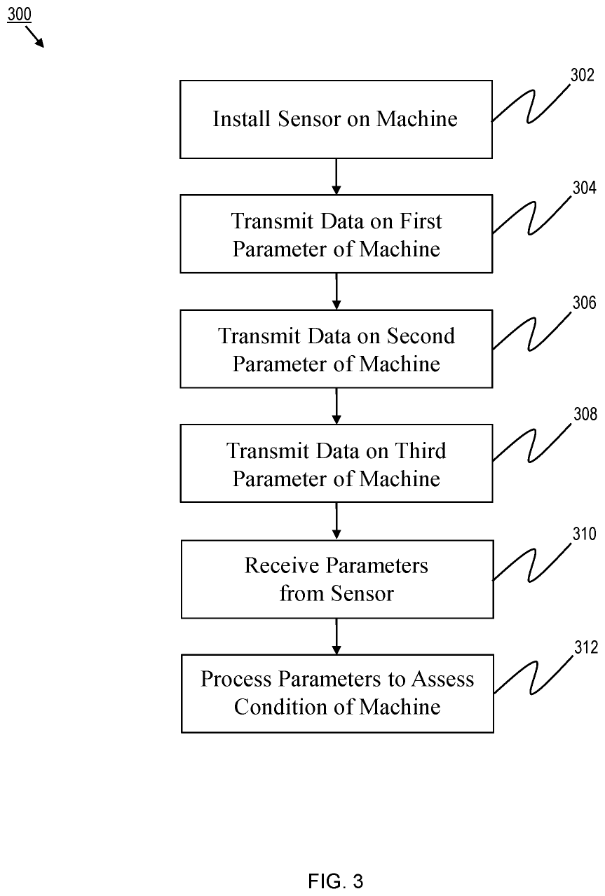

A method 300 of monitoring machinery and/or associated structure, according to an exemplary embodiment, is shown in FIG. 3. According to the method, a sensor (e.g., the CM sensor 100) is placed on/near or otherwise interfaced with a machine to be monitored in step 302. The sensor is capable of monitoring multiple parameters of condition for the corresponding machine in real-time. Next, the sensor transmits data on a first parameter (e.g., temperature) of the machine in step 304. Then, the sensor transmits data on a second parameter (e.g., vibration in three axes) of the machine in step 306. Then, the sensor transmits data on a third parameter (e.g., ultrasonic emissions) of the machine in step 308. The data (i.e., the first parameter data, the second parameter data, and the third parameter data) is received by a device, such as a computer, over a network in step 310. The device can then process the data to assess the current condition of the machine in step 312.

It will be appreciated that the scope of the general inventive concepts are not intended to be limited to the particular exemplary embodiments shown and described herein. From the disclosure given, those skilled in the art will not only understand the general inventive concepts and their attendant advantages, but will also find apparent various changes and modifications to the devices, systems, and methods disclosed. It is sought, therefore, to cover all such changes and modifications as fall within the spirit and scope of the general inventive concepts, as described and claimed herein, and any equivalents thereof.

1. A sensor for monitoring multiple parameters associated with a machine, the sensor comprising:
a temperature module for monitoring a temperature associated with the machine and generating first data based thereon;
a vibration module for monitoring vibration levels associated with the machine relative to three distinct axes and generating second data based thereon;
an ultrasonic emissions module for monitoring ultrasonic emissions associated with the machine and generating third data based thereon;
a communications module for transmitting the first data, the second data, and the third data to a source external to the sensor; and
a power module for providing power to at least one of the temperature module, the vibration module, the ultrasonic emissions module, and the communications module.

2. The sensor of claim 1, further comprising a housing for encasing the temperature module, the vibration module, and the ultrasonic emissions module.

3. The sensor of claim 2, wherein the housing includes a mounting means extending therefrom.

4. The sensor of claim 3, wherein at least a portion of the mounting means is threaded.

5. The sensor of claim 2, further comprising an antenna connected to the housing.

6. The sensor of claim 1, wherein the communications module is operable to transmit the first data, the second data, and the third data wirelessly.

7. The sensor of claim 1, wherein the power module includes one or more batteries.

8. The sensor of claim 7, wherein the batteries are rechargeable.

9. The sensor of claim 1, wherein the power module includes one or more capacitors.

10. A system for monitoring multiple parameters associated with a machine, the system comprising: a sensor interfaced with the machine so as to be able to simultaneously monitor a temperature associated with the machine, vibration levels associated with the machine relative to three distinct axes, and an ultrasonic emissions level associated with the machine, said sensor including means for wirelessly transmitting data relating to the temperature, the vibration level, and the ultrasonic emissions level to a device external to the sensor, and said sensor including means for powering the sensor.

11. The system of claim 10, wherein the device is a transponder for relaying the data over a network.

12. The system of claim 10, wherein the means for powering comprises one or more batteries.

13. The system of claim 12, wherein the batteries are rechargeable.

14. The system of claim 10, wherein the means for powering comprises one or more capacitors.

15. A method of monitoring multiple parameters associated with a machine, the method comprising:
installing a sensor on the machine;
generating first data within the sensor relating to a temperature associated with the machine;
generating second data within the sensor relating to a vibration level associated with the machine;
generating third data within the sensor relating to an ultrasonic emissions level associated with the machine; and
wirelessly transmitting the first data, the second data, and the third data to a device external to the sensor.
